(19) United States
(12) Patent Application Publication
(10) Pub. No.: US 2009/0053534 A1
(43) Pub. Date: Feb. 26, 2009

(54) COATING COMPOSITIONS

(76) Inventor: Robert Prunchak, East Windsor, NJ (US)

Correspondence Address: BASF CATALYSTS LLC, 100 CAMPUS DRIVE, FLORHAM PARK, NJ, 07932, US

(21) Appl. No.: 11/842,418

(22) Filed: Aug. 21, 2007

(51) Int. Cl. B32B 17/08; C03C 17/38; C03C 8/20; C09K 17/42

(52) U.S. Cl. 428/438; 106/287.17; 106/287.19; 106/287.29; 106/287.32; 106/287.34; 428/426; 523/170; 65/43

(57) ABSTRACT

Coating compositions, articles having a coating layer and an enamel layer applied thereto, enamel systems and processes for applying a coating to a glass composite are described. According to one or more embodiments, the coating composition comprises a refractory particulate material in an amount at least about 30% by weight. In other embodiments, the coating composition has an average particle size of less than about 30 μm. In yet other embodiments, the coating composition can be applied to a glass composite having a layer of enamel disposed on the second surface, using a single firing step.

### TECHNICAL FIELD

Embodiments of the invention relate to coating compositions comprising refractory particulate, articles having an enamel layer and a coating composition applied thereto, enamel systems and methods of application to glass substrates.

### BACKGROUND

Automotive windshields typically comprise two sheets of glass bonded to a pliable interlayer usually made up of polyvinyl butyrate (“PVB”). The two sheets of glass are usually curved, or otherwise shaped, during the manufacturing process. An enamel may be added to one or more of the glass surfaces. Such enamels commonly function to obscure and prevent UV light degradation of the organic adhesives which adhere the glass to a car chassis. Further, the enamel may also function as antennae or resistance heaters when made of conductive materials. Such enamels typically include glass frit(s), organic medium (containing binder(s), solvents, and/or surfactants and defoamers). Other non-limiting examples of ingredients included in such enamels include one or more pigments and for crystallizable enamels, the inclusion of nucleating agent(s).

After application to the glass and firing the part to the proper temperature, it is desirable for the enamel to develop a substantially non-porous structure having uniform opacity and color. Furthermore, during the firing and bending process, it is desirable that the enamel does not transfer onto any other glass surface.

There is interest within the industry to develop an enamel that could be printed on the second surface position of a glass composite, that is, between the glass sheets instead of on an outer surface of the composite. FIG. 1 shows an example of a finished structure, which comprises a first glass sheet 10 having a first surface 11 and a second surface 12, a second glass sheet 20 having a third surface 23 and a fourth surface 24, an interlayer 30 disposed between the first glass sheet 10 and the second glass sheet 20 and a glass enamel ink layer 40 disposed on the second surface 12.

A benefit of locating the enamel between the two glass sheets or substrates is that the enamel can visually hide any electrical connections that may be a part of the interlayer, such as wires or busbars. Another benefit is that the enamel is protected from the environment, i.e. acid rain, detergents or cleaners that may tend to degrade the enamel over time.

Despite the benefits of application of enamels on the second surface, transfer of the enamel onto the third surface has developed as a problem. This problem is exaggerated in areas which support a significant portion of the weight of the top glass during the heat treatment (bending) of the glass, such as the corners of the stacked glass sheets. Accordingly, there is a need to prevent transfer of the second surface enamel to the third surface.

In addition, application of enamels on the second surface often requires a dual-firing process to fully decompose the organic components of the enamel. This process requires printing the enamel onto a first glass sheet and firing the first glass sheet to thermally decompose the binders while the glass sheet remains substantially flat. A second glass sheet is then stacked on top of the first glass sheet. The stack is then heated to elevated temperatures and shaped to the desired curvature or shape. Decomposition of the organic components is necessary for the dried enamel finish to have a substantially non-porous structure with uniform opacity and color. However, a disadvantage of such a process is that the dual firing process to thermally decompose the binders present in the enamel is expensive. Accordingly, there is a need to provide a glass composite having an enamel disposed on the second surface, and methods for making the same. It would be advantageous to provide a method of manufacture which requires only one firing step.

### SUMMARY

One or more embodiments of the present invention provide a coating comprising refractory particulate materials, including refractory powders, whiskers or flakes, in an amount of at least about 30% by weight. As used herein, the term “refractory particulate materials” shall include materials having a melting point or glass transition temperature greater than 700° C. In one version of the invention, at least a portion of the refractory particulate materials also function as nucleating agents. Other embodiments of the invention include a coating also having a medium which contains a binder medium; an oxidizing agent and preservative(s). In accordance with one or more embodiments, the coating can be applied to the enamel layer to prevent transfer of the enamel to the third surface of a glass composite, while still avoiding the use of a dual-firing process. Further, other embodiments of the present invention include an enamel system having a coating, as described herein, and an enamel. It is also envisioned that the coating could be applied to the third side of the glass composite or the underside of the top piece of glass. In general, embodiments of the coating described herein can be used with enamels which typically include a glass frit, binder medium and an oxidizing agent. Other non-limiting examples of such enamels further include one or more pigments.

In one or more embodiments, the coating uses one or more refractory particulate materials such as oxides, metals, borides and nitrides. Further examples of refractory particulate materials include, but are not limited to, silicates, aluminates, zirconates, spinels, titanates, aluminosilicate glass powder, zirconium diboride, silicon nitride, other similar materials, and combinations thereof. In one embodiment at least a portion of the refractory particulate materials function as nucleating agents for the frits used in the enamel. In other embodiments, one or more nucleating agents are included in the refractory particulate materials, while in other embodiments, the refractory particulate materials are one or more nucleating agents. Examples of suitable nucleating agents include bismuth silicates, zinc silicates, titania, titanates, zirconia, zirconates, phosphorous, phosphates, aluminates and/or combinations thereof. In some embodiments, the coating utilizes glycidyl azide polymer (GAP), poly(3-nitratomethyl-3-methyl oxetane), poly(3,3-azidomethyl oxetane), poly(3-azidomethyl-3-methyl oxetane), poly(glycidyl nitrate), poly(vinylnitrate), polynitrophenylene, nitramine polyethers, and nitrated polybutadienes, nitrocellulose and/or combinations thereof as binders in the binder medium. Some embodiments also include liquid vehicles in the binder medium such as diethylene glycol monbutyl ether, terpineol, isopropanol, tridecanol, water, 2,2,4-trimethyl-1,3-pentanediol monoisobutyrate. In further embodiments of the present invention, the coating uses oxidizing agents such as peroxides, chlorates, percholorates, nitrates, permanganates and/or combinations thereof. According to other embodiments of the present invention, preservatives such as boric acid, phosphoric acid, hydrochloric acid, nitric acid, sulphuric acid and/or combinations thereof can be included in the coating.

In some embodiments of the invention, the particles of the coating have an average size of less than 30 μm.

Another aspect of the invention pertains to articles having a first glass sheet, an enamel layer applied to a first glass sheet, a coating layer formed on or adjacent to the enamel layer, a second glass sheet placed in contact with the coating layer and an interlayer inserted in between the first and second glass sheets. In accordance with one or more embodiments, the coating used in such articles includes one or more refractory particulate materials in an amount of at least about 30% by weight. Alternate examples of the invention incorporate nucleating agents as the refractory particulate materials. In one or more embodiments, the glass sheets of the articles described herein are windshields. In other embodiments, the glass sheets of the articles are sidelites. In another embodiment, the glass sheets of the articles are backlites.

Another aspect of the present invention includes a process for producing a glass composite having a coating layer comprising a refractory particulate material in an amount at least about 30% by weight in a glass composite. In one embodiment of the process these refractory particulate materials can include one or more nucleating agents. In one or more embodiments, the glass composite is produced by first applying an enamel layer to the second surface of a sheet of glass. A coating is then applied on top of the enamel layer. A second glass sheet is then placed on top of the coating layer, followed by the firing and shaping process. Some embodiments of the present invention include a drying step in which the enamel layer is dried using a low temperature heat cycle prior to applying the coating layer. Some embodiments of the present invention include a drying step in which the coating layer is also dried using a low temperature heat cycle prior to placing the second glass sheet on top of the first glass sheet. Alternatively, the coating layer can be applied to the third surface, or the bottom surface of the top sheet of glass, and subsequently dried. In at least one embodiment, the coating layer has a thickness in the range of about 5 μm to about 40 μm. According to one or more embodiments, the coating layer is only applied near the edge of the first glass sheet or second glass sheet. In one embodiment, the coating is applied only in regions known to present enamel transfer problems such as in the corner regions of the glass and/or in other such areas expected to support the weight of the glass during the firing or bending process. In other embodiments, the glass sheets are separated after firing and shaping and a PVB interlayer is inserted in between the sheets. Some embodiments include a step in which the separated glass sheets are washed prior to inserting the PVB interlayer. In one embodiment of the invention, any residual components of the coating, such as the refractory particulate materials, are washed off, leaving a uniform enamel surface and an undamaged top sheet of glass. According to one or more embodiments, the glass sheets are then bonded to the interlayer to create a glass composite.

The foregoing has outlined rather broadly certain features and technical advantages of the present invention. It should be appreciated by those skilled in the art that the specific embodiments disclosed may be readily utilized as a basis for modifying or designing other structures or processes within the scope of the present invention. It should also be realized by those skilled in the art, that such equivalent constructions do not depart form the spirit and scope of the invention as set forth in the appended claims.

### BRIEF DESCRIPTION OF THE DRAWINGS

FIG. 1 represents an example of a glass composite having an enamel and coating disposed on the second surface.

FIG. 2 shows an embodiment of a glass composite having an enamel disposed on the second surface and a coating disposed on the third surface.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

In accordance with one embodiment of the invention, a coating composition comprises refractory particulate material in an amount of at least about 30% by weight, a binder medium, an oxidizing agent and preservative.

In the case of large glass composite products having an enamel layer disposed on the second surface, such as automotive windshields, it is believed that as the glass sheets are fired, the outer surfaces begin to expand, so that for at least a portion of the firing cycle, the majority of the weight of the top glass sheet is supported by a small region of the enamel layer located on the bottom sheet of glass. Generally, the enamel disposed in the corners of the glass bear the majority of the weight of the glass sheet. As the glass sheets approach similar temperatures, this bowing is reduced and ultimately eliminated as the two glass sheets slump under their own weight. At this point the majority of the weight of the top glass is more or less supported uniformly by the bottom sheet of glass. However, during at least a portion of the firing cycle, the bowing of the glass sheets causes a significant weight to be placed on a portion of the enamel which tends to damage the enamel and, in some cases, causes the enamel to transfer or bond to the third surface of the top sheet of glass In some cases, the transfer is so significant that the two sheets of glass cannot be separated to allow for the insertion of the PVB interlayer. While the present invention is not intended to be bound by a particular theory of operation, it is believed that the presence of the refractory coating provides allows the weight and/or movement of the top sheet of glass to be more evenly distributed, and/or slide across the enamel layer without damaging it. In one embodiment, at least a portion of the refractory particulate material contains at least one nucleating agent. In other embodiments, the refractory particulate materials are one or more nucleating agents. It is believed that the elevated presence of nucleating agent in the coating promotes and increases the rate of localized crystallization of the top surface of the enamel layer. Further, without being limited by theory, the particles of the coating also prevent the enamel from sticking to the second glass sheet by dispersing the weight of the second glass sheet.

In addition, it is believed that an increase in the amount of nucleating agent found in some enamels does not produce the same results as applying a layer of coating described in one or more embodiments of the present invention. Indeed, testing of enamels with varying compositions has revealed that an increased amount of nucleating agent results in an enamel having an elevated melting point, yielding a porous finish having poor opacity and poor color. Without being limited by theory, it is believed that application of a coating, as described in one or more embodiments of the present invention increases crystallization of the enamel without compromising the porosity and opacity of the enamel.

In one embodiment, the refractory particulate material includes one or more nucleating agent in an amount of at least about 1% by weight. In other embodiments, the refractory particulate material is one or more nucleating agents. Examples of nucleating agents include bismuth silicate(s), zinc silicates, titania, titanates, zirconia, zirconates, phosphorous, phosphates, aluminates and/or combinations thereof. In addition, other nucleating agents known in the art may also be used in other embodiments of the coating.

In other embodiments of the invention, the coating further includes a binder medium which can include a binder and a liquid vehicle. Examples of binders that can be used in accordance with one or more aspect of the present invention include glycidyl azide polymer (GAP), poly(3-nitratomethyl-3-methyl oxetane), poly(3,3-azidomethyl oxetane), poly(3-azidomethyl-3-methyl oxetane), poly(glycidyl nitrate), poly(vinylnitrate), polynitrophenylene, nitramine polyethers, and nitrated polybutadienes, nitrocellulose and/or combinations thereof. Some embodiments of the present invention utilize other binders known in the art. Non-limiting examples of liquid vehicles include diethylene glycol monbutyl ether, terpineol, isopropanol, tridecanol, water, 2,2,4-trimethyl-1,3-pentanediol monoisobutyrate.

In one or more embodiments of the present invention, the coating includes an oxidizing agent. Some embodiments of the coating utilize peroxides, chlorates, percholorates, nitrates, permanganates and/or combinations thereof as oxidizing agents. At least one embodiment of the present invention incorporates other oxidizing agents known in the art.

In one or more embodiments of the present invention, a preservative is incorporated into the coating composition. Some embodiments utilize preservatives such as boric acid, phosphoric acid, hydrochloric acid, nitric acid, sulphuric acid and/or combinations thereof, while other embodiments utilize other preservatives known in the art.

As previously mentioned, when used in glass composites, the particles of the coating also aid in preventing adhesion between the enamel layer disposed on a first glass sheet and the second glass sheet. While not wishing to be limited by theory, it is believed that the effectiveness of the particles is related to variations in their size. Further, the size of the particles depends on the method in which the coating is applied. For example, as more fully described herein, in one embodiment, the coating may be applied by screen printing methods. Accordingly, the particle must be able to pass through the mesh screen used to apply the coating. In one or more embodiments of the present invention the particles of the coating have an average particle size of less than about 30 μm. In at least one embodiment the coating forms a layer having a thickness from about 5 μm to about 40 μm.

As discussed in the preceding paragraph, the coating, as described in one or more embodiments of the invention, may be applied using various methods. Some embodiments of the invention apply the coating described herein by wet spraying and/or screen printing. Other embodiments apply the coating described according to one or more aspects of the present invention by using other application methods known in the art. Some embodiments of the present invention require the coating to be in paste form for proper application.

In accordance with at least one embodiment of the invention, the coating is suitable for application to automotive windshields, sidelites or backlites.

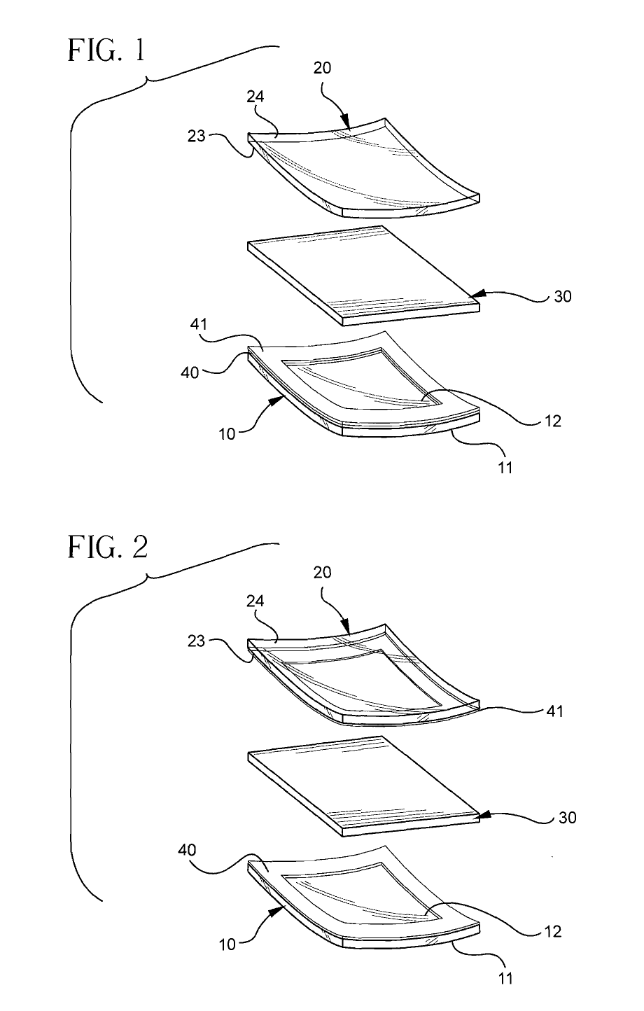

Referring now to FIG. 1, another aspect of the present invention pertains to an article having the following components: a first glass sheet 10 having a first surface 11 and a second surface 12, an enamel layer 40 disposed on the second surface 12, a coating layer 41 having a refractory particulate material in an amount of at least about 30% by weight disposed on top of the enamel layer and the first glass sheet, a second glass sheet 20 having a third surface 23 and a fourth surface 24, wherein the third surface 23 is in contact with the coating layer 41 and an interlayer 30 is disposed in between the first glass sheet 10 and the second glass sheet 20. In accordance with one or more embodiments of the present invention, the first and second glass sheets of the articles described herein are automotive windshields. In other embodiments of the present invention, the first and second glass sheets are sidelites or rear backlites.

FIG. 2 shows another example of an article including a first glass sheet 10 having a first surface 11 and a second surface 12 and a second glass sheet 20 having a third surface 23 and a fourth surface 24. The second surface 12 of the article has a enamel layer 40 disposed thereon and the third surface of the article 23 has a coating layer 41 having a refractory particulate material in an amount of at least about 30% by weight disposed thereon. The article also includes an interlayer 30 disposed in between the first glass sheet 10 and the second glass sheet 20.

Another aspect of the present invention pertains to an enamel system. The enamel system according to at least one embodiment comprises an enamel and a coating having one or more refractory particulate materials in an amount at least about 30% by weight.

Non-limiting examples of enamels, as described herein, include enamels having the following basic components: a glass frit, binder and an oxidizing agent. Other non-limiting examples of enamels can also include one or more pigments.

According to one or more embodiments of the enamel system, non-limiting examples of nucleating agents include bismuth silicate(s), zinc silicate titania, titanates, zirconia, zirconates, phosphorous, phosphates, aluminates and/or combinations thereof. Other embodiments use other nucleating agents known in the art.

In other embodiments, the coating component of the enamel system further includes a binder medium, an oxidizing agent and a preservative. In some embodiments, binder medium of the enamel system includes binders and a liquid vehicle. Suitable binders include glycidyl azide polymers (GAP), poly(3-nitratomethyl-3-methyl oxetane), poly(3,3-azidomethyl oxetane), poly(3-azidomethyl-3-methyl oxetane), poly(glycidyl nitrate), poly(vinylnitrate), polynitrophenylene, nitramine polyethers, and nitrated polybutadienes, nitrocellulose and/or combinations thereof, as well as other binders known in the art. Non-limiting examples of liquid vehicles include diethylene glycol monbutyl ether, terpineol, isopropanol, tridecanol, water, 2,2,4-trimethyl-1,3-pentanediol monoisobutyrate.

In certain embodiments of the present invention, the enamel system includes an oxidizing agent such as peroxides, chlorates, percholorates, nitrates, permanganates and/or combinations thereof. Other oxidizing agents known in the art may also be used in the coating, in accordance with one or more aspect of the present invention. One or more embodiments of the present invention include an enamel system with a coating having a preservative selected from the following group: boric acid, phosphoric acid, hydrochloric acid, nitric acid, sulphuric acid and combinations thereof.

In one or more embodiments of the present invention, the coating of the enamel system has a coating with an average particle size of less than about 30 μm.

Another aspect of the present invention provides a process for producing a glass composite. In an exemplary embodiment, a process includes applying an enamel in a predetermined pattern on one side of a first glass sheet; applying a coating onto the enamel and first glass sheet, the coating comprising a refractory particulate material in an amount of at least about 30% by weight; placing a second glass sheet directly on top the first glass sheet, whereby the coating is in direct contact with the second glass sheet; firing both sheets of glass and simultaneously shaping the glass through a bending lehr; separating the two glass sheets and inserting an interlayer; and rejoining the two glass sheets by bonding them to each side of the interlayer so that the interlayer is in between the two glass sheets. At least one embodiment of the process includes the step of drying the enamel layer before applying the coating onto the enamel. Further embodiments include the step of drying the coating layer prior to placing the second glass sheet directly on top of the first glass sheet.

In another example, the process includes the steps of applying an enamel in a predetermined pattern on one side of a first glass sheet; applying a coating to one side of a second glass sheet; placing a second glass sheet directly on top of the first glass sheet, whereby the coating is in direct contact with the enamel of the first glass sheet; firing both sheets of glass and simultaneously shaping the glass through a bending lehr; separating the two glass sheets and inserting an interlayer; and rejoining the two glass sheets by bonding them to each side of the interlayer so that the interlayer is in between the two glass sheets. At least one embodiment of the process includes the step of drying the enamel layer before placing the second glass sheet directly on top of the first glass sheet. Further embodiments include the step of drying the coating layer prior to placing the second glass sheet directly on top of the first glass sheet.

In at least one embodiment, the process includes applying the coating directly onto the enamel and on one side of the second glass sheet. In further embodiments, the coating is applied only to the edge portions of the first glass sheet and/or second glass sheet. In yet further embodiments the coating layer has a thickness measuring from the range of about 5 μm to 40 μm.

In some embodiments of the process, the coating is free of nucleating agents, an oxidizing agent or a preservative. In one embodiment of the process, the refractory particulate material includes at least a portion of nucleating agent. In yet a further embodiment of the process, the refractory particulate material is one or more nucleating agents.

In one or more method embodiments of the present invention, the coating layer is applied by wet spraying and/or screen printing. Some embodiments utilize other methods to apply the coating layer. In some embodiments of the present invention, the enamel layer is dried at a temperature of 50° C. to 150° C. after application. In other embodiments of the process, the coating layer is also dried at a temperature of 50° C. to 150° C. after application. Without being limited by theory, it is believed that the process of producing a glass composite according to one or more embodiments of the present invention allows for application of an enamel to the second surface or third surface of a glass composite in a cost-efficient manner by using only one firing step.

In other embodiments of the present invention, the enamel layer and/or coating layer are allowed to air dry after application. In yet other embodiments, the process of producing a glass composite further includes a step of washing the separated glass sheets prior to insertion of the interlayer. One or more embodiments of the present invention, the coating is applied only near the edge portions of the first glass sheet.

Embodiments of the invention may be more readily understood by the following non-limiting examples.

### COATING EXAMPLES

Each example (A-J) was prepared using a general procedure. The general procedure includes batching and dispersing the examples using triple roll milling. Alternative dispersion processes known in the industry such as bead milling, sand milling and colloidal milling could also be used to disperse the solid particles in the organic binder medium. Example D includes a product sold under the trade name 3M G200 in an amount measuring about 65% weight by volume. The Material Safety Data Sheet and Product Information Sheet for this product lists the composition as a “Silica-Alumina Ceramic.”

TABLE 1
COMPOSITION OF EXAMPLES A-J

| Components by | | | | | | | | | | |
|---|---|---|---|---|---|---|---|---|---|---|
| weight % by vol. | Ex. A | Ex. B | Ex. C | Ex. D | Ex. E | Ex. F | Ex. G | Ex. H | Ex. I | Ex. J |
| aluminum oxide | 65 | — | — | — | — | — | — | — | 43.5 | 43.5 |
| Mullite | — | 65 | — | — | — | — | — | — | — | — |
| boron nitride | — | — | 65 | — | — | — | — | — | — | — |
| 3M ™ G200 | — | — | — | 65 | — | — | — | — | — | — |
| cerium oxide | — | — | — | — | 65 | — | — | — | — | — |
| copper chromite | — | — | — | — | — | 65 | — | — | — | — |
| Bi₄Si₃O₁₂ | — | — | — | — | — | — | 65 | — | 21.5 | — |
| nucleating agent | | | | | | | | | | |
| titania (Rutile) | — | — | — | — | — | — | — | 65 | — | 21.5 |
| nucleating agent | | | | | | | | | | |
| BASF L509 | 4.7 | 4.7 | 4.7 | 4.7 | 4.7 | 4.7 | 4.7 | 4.7 | 4.7 | 4.7 |
| binder medium | | | | | | | | | | |
| ZnO2 powder | 4 | 4 | 4 | 4 | 4 | 4 | 4 | 4 | 4 | 4 |
| A6420 stabilizer | 26.3 | 26.3 | 26.3 | 26.3 | 26.3 | 26.3 | 26.3 | 26.3 | 26.3 | 26.3 |
| Total | 100 | 100 | 100 | 100 | 100 | 100 | 100 | 100 | 100 | 100 |

A layer of 53-0091 in L509 (BASF) obscuration enamel was printed onto eleven glass slides having length and width measuring 100 mm×100 mm and having a thickness measuring 2.2 mm thick. A 200 mesh screen was used to print the enamel onto the glass slides or parts. The printed image consisted of a band measuring 25 mm wide and 25 μm thick which formed a perimeter on each glass slide to mimic a typical obscuration enamel band used on a windshield. The parts were dried in a convection oven at 150° C. for 10 minutes and then cooled to room temperature. Part 1 was labeled “Standard”. Each of the other ten parts was overprinted with the Examples A through J using a separate 200 mesh screen with a special pattern and was labeled Parts 2-11, respectively. This screen pattern consisted of four 10 mm×10 mm squares, each located at one of the four corners of the parts directly over the corner of the enamel layer. The parts were then dried in a convection oven at 150° C. for 10 minutes and then cooled to room temperature. Thereafter, an un-printed glass having length dimensions 100 mm×100 mm and thickness measuring 2.2 mm was placed on top of each printed part. For Part 1, marked “Standard,” this second piece of glass was in direct contact with the enamel layer. For Parts 2-11, this second piece of glass was in contact with the coating that was printed over the enamel layer.

Each individual glass stack was placed into a stainless steel fixture having an open center with side portions which support the glass around each edge. A special test rig was also used that allowed significant weight to be applied to the corners of the glass stack during the firing cycle. The test rig consisted of a stainless steel sheet with length dimensions measuring 100 mm×100 mm welded to four posts with diameters measuring 5 mm. The test rig was placed on the glass stack and positioned so that each post was located at each corner of the glass stack. The use of the test rig allowed for the placement of additional weight onto the four corners of the glass while the parts were being fired. In these examples, a hot crucible weighing 1 kg was also placed onto the test rig during the firing cycle so that the weight was focused at the corners of the glass stacks.

The glass stacks, along with the stainless steel fixtures, test rigs and crucible were then fired in a kiln for 10 minutes at 600° C. and thereafter removed from the kiln and cooled to room temperature. The glass stacks were separated after cooling. The parts were then inspected visually.

TABLE 2
COMPARISON OF ENAMEL LAYERS

| | Part No. | | | | | |
|---|---|---|---|---|---|---|
| | Part 1 | Part 2 | Part 3 | Part 4 | Part 5 | Part 6 |
| | Example No. | | | | | |
| | No | | | | | |
| | Coating | Ex. A | Ex. B | Ex. C | Ex. D | Ex. E |
| Transfer of | Moderate | None | None | None | None | None |
| obscuration | | | | | | |
| enamel to top | | | | | | |
| glass surface | | | | | | |
| Damage to | Moderate | Slight | Slight | Very | Very | Very |
| obscuration | | | | Slight | Slight | Slight |
| enamel | | | | | | |

Part No.

| | | | | |
|---|---|---|---|---|
| Part 7 | Part 8 | Part 9 | Part 10 | Part 11 |

Example No.

| | Ex. F | Ex. G | Ex. H | Ex. I | Ex. J |
|---|---|---|---|---|---|
| Transfer of | None | None | None | None | None |
| obscuration | | | | | |
| enamel to top | | | | | |
| glass surface | | | | | |
| Damage to | Very | None | None | None | None |
| obscuration | Slight | | | | |
| enamel | | | | | |

### Comparison of Enamel Layer on Parts 1-11:

Part 1, labeled “Standard” exhibited some transfer of the enamel to the top piece of glass. The transfer was enough to damage the enamel layer. This damage to the enamel layer was easily visible.

Parts 2, 3, 4, 5, 6 and 7, with Examples A, B, C, D, E and F printed thereon, respectively showed improved results. The enamel layers of the Parts did not transfer onto the top piece of glass. However slight damage to each of the enamels in varying degrees was observed. The residue from each of the Examples was also easily washed off.

Parts 8, 9, 10 and 11, with Examples G, H, I and J printed thereon, exhibited excellent results. No transfer of the enamel layer to the top piece of glass was observed. Further there was no damage to the underlying enamel layer. The residue from each of the Examples was also easily washed off.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A coating composition comprising:
a refractory particulate material in an amount of at least about 30% by weight;
a binder medium;
an oxidizing agent; and
a preservative, wherein when the coating composition is disposed between two glass sheets in a spaced relation to provide an automobile windshield, and one of the glass sheets has an enamel thereon, the coating prevents the enamel from sticking to the other of the glass sheets during manufacture of the windshield.

2. The coating of claim 1, wherein the refractory particulate material is selected from the group consisting of silicates, aluminates, zirconates, spinels, titanates, aluminosilicate glass powder, borides, nitrides and combinations thereof.

3. The coating of claim 1, wherein the refractory particulate material further comprises a nucleating agent selected from a group consisting of bismuth silicate(s), zinc silicates, titania, titanates, zirconia, zirconates, phosphorous, phosphates, aluminates and combinations thereof.

4. The coating of claim 1, wherein the binder medium contains an energetic resin selected from a group consisting of glycidyl azide polymer (GAP), poly(3-nitratomethyl-3-methyl oxetane), poly(3,3-azidomethyl oxetane), poly(3-azidomethyl-3-methyl oxetane), poly(glycidyl nitrate), poly(vinylnitrate), polynitrophenylene, nitramine polyethers, and nitrated polybutadienes, nitrocellulose and combinations thereof.

5. The coating of claim 1, wherein the oxidizing agent is selected from a group consisting of peroxides, chlorates, percholorates, nitrates, permanganates and combinations thereof.

6. The coating of claim 1, wherein the preservative is selected from a group consisting of boric acid, phosphoric acid, hydrochloric acid, nitric acid, sulphuric acid and combinations thereof.

7. The coating of claim 1, wherein the average particle size of the particulate material is less than about 30 μm.

8. An article comprising:
a first glass sheet having a first surface and a second surface;
an enamel layer disposed on the second surface;
an coating layer having a composition comprising a refractory particulate material in an amount of at least about 30% by weight disposed on top of the enamel layer and the first glass sheet;
a second glass sheet having a third surface and a fourth surface, the third surface is in contact with the coating layer; and
an interlayer disposed in between the first glass sheet and the second glass sheet.

9. An enamel system comprising an enamel and a coating of claim 1.

10. The enamel system of claim 9, wherein the refractory particulate material further comprises a nucleating agent selected from a group consisting of bismuth silicate, titania, titanates, zirconia, zirconates, phosphorous, phosphates, aluminates and combinations thereof.

11. The enamel system of claim 9, wherein the binder medium of the coating comprises a liquid vehicle and a binder selected from a group consisting of glycidyl azide polymer (GAP), poly(3-nitratomethyl-3-methyl oxetane), poly(3,3-azidomethyl oxetane), poly (3-azidomethyl-3-methyl oxetane), poly(glycidyl nitrate), poly(vinylnitrate), polynitrophenylene, nitramine polyethers, and nitrated polybutadienes, nitrocellulose and combinations thereof.

12. The enamel system of claim 9, wherein the oxidizing agent of the coating is selected from a group consisting of peroxides, chlorates, percholorates, nitrates, permanganates and combinations thereof.

13. The enamel system of claim 9, wherein the preservative of the coating is selected from a group consisting of boric acid, phosphoric acid, hydrochloric acid, nitric acid, sulphuric acid and combinations thereof.

14. The enamel system of claim 9, wherein the average particle size of the particulate materialis less than about 30 μm.

15. An article comprising:
a first glass sheet having a first surface and a second surface;
an enamel layer disposed on the second surface;
a layer of refractory particulate material disposed on top of the enamel layer and the first glass sheet;
a second glass sheet having a third surface and a fourth surface, the third surface is in contact with the coating layer; and
an interlayer disposed in between the first glass sheet and the second glass sheet.

16. The article of claim 15, wherein the layer of refractory particulate material further comprises one or more nucleating agent.

17. A process for producing a glass composite comprising:
applying an enamel in a predetermined pattern on one side of a first glass sheet having a first surface and a second surface;
applying a coating on the enamel and first glass sheet, the coating comprising a refractory particulate material in an amount of at least about 30% by weight;
placing a second glass sheet having a third surface and a fourth surface directly on top the first glass sheet, whereby the coating is in direct contact with the third surface of the second glass sheet;
firing both sheets of glass and simultaneously shaping the glass composite;
separating the two glass sheets and inserting an interlayer; and
rejoining the two glass sheets by bonding them to each side of the interlayer so that the interlayer is in between the two glass sheets.

18. The process of claim 17, wherein the enamel is dried prior to application of the coating.

19. The process of claim 17, wherein the coating is applied to the third surface of the second glass sheet.

20. The process of claim 17, wherein the coating is applied to form a layer having a thickness in the range of about 5 μm to about 40 μm.
